(19) United States
(12) Patent Application Publication
(10) Pub. No.: US 2004/0032387 A1
(43) Pub. Date: Feb. 19, 2004

(54) Device and method for driving liquid crystal display

(76) Inventors: Hsiao-Yi Lin, Hsinchu (TW); Ching-Ching Chi, Hsinchu (TW)

Correspondence Address: MADSON & METCALF, GATEWAY TOWER WEST, SUITE 900, 15 WEST SOUTH TEMPLE, SALT LAKE CITY, UT, 84101

(21) Appl. No.: 10/422,192

(22) Filed: Apr. 24, 2003

(30) Foreign Application Priority Data
Aug. 19, 2002 (TW) 091118721

(51) Int. Cl. G09G 3/36

(52) U.S. Cl. 345/98

(57) ABSTRACT

A device for driving a thin film transistor array of a liquid crystal display is provided. The device includes an input line, a plurality of latch units, and a plurality of digital-to-analog converters. The input line is used for receiving therefrom a plurality of digital image signals. The plurality of latch units are in communication with the input line for latching the digital image signals. The plurality of digital-to-analog converters are in communication with and disposed between the latch units and the data lines, for receiving more than one of the latched digital image signals, converting the latched digital image signals into analog image signals, and outputting the analog image signals to display cells in the same driven scan line via corresponding data lines synchronously. A method for driving a thin film transistor array of a liquid crystal display is also provided.

### FIELD OF THE INVENTION

The present invention relates to a driving device, and more particularly to a device for driving a liquid crystal display. The present invention also relates to a method for driving a liquid crystal display.

### BACKGROUND OF THE INVENTION

Liquid crystal displays (LCDs) are widely used in portable televisions, laptop personal computers, notebooks, electronic watches, calculators, mobile phones and office automation devices, etc. due to their advantages of small size, light weight, low driving voltage, low power consumption and good portability.

FIG. 1(a) is a schematic circuit block diagram illustrating the configuration of the driving circuit and active matrix of a conventional liquid crystal display.

The active matrix is implemented by a thin film transistor array (TFT array) 100. As shown in FIG. 1(b), each cell in the TFT array 100 comprises a capacitor structure 1001 for storing analog video signals, and a thin film transistor 1002. The thin film transistor array 100 further comprises a plurality of scan lines and data lines. Via each scan line, all the thin film transistors of the same row are controlled in either a switching-on or switching-off state. The data lines transmit analog video signals to the switched-on cells electrically connected thereto.

The driving circuit comprises a data shift register 105, a scan shift register 110, a plurality of data switches C1˜Cn, and a plurality of N-bit digital-to-analog converters (DACs) D1˜Dn. The scan shift register 110 comprises a plurality of scan register units Al˜Am, which are electrically connected in series with each other. Each of the scan register units A1˜Am is electrically connected to a corresponding scan line. The scan lines are successively driven by the scan shift register 110 so as to sequentially turn on the thin film transistors row by row. The data shift register 105 comprises a plurality of data register units B1˜Bm. The data register units B1˜Bm successively switch on the data switches C1˜Cn. Each of the data switches C1˜Cn comprises N transistors. For neat drawings, however, only one transistor is shown in the drawing. When a data switch is on, the digital image signals inputted from N data lines Din simultaneously pass through the N transistors. Meanwhile, the N-bit digital-to-analog converters D1˜Dn coupled to the data switches C1˜Cn, respectively, receive the digital image signals from the on-state switch. The digital image signals are then converted into analog image signals by the corresponding N-bit digital-to-analog converters D1˜Dn, and then enter data lines of the TFT array 100.

The operation of the above liquid crystal display will be illustrated as follows.

When the first digital image signal is inputted via the N data lines Din, the data switch C1 is switched on by the data shift register 105, and the others are kept off. The first digital image signal is then converted into a first analog image signal by means of the N-bit digital-to-analog converter D1, and the first analog image signal enters only the first data line of the TFT array 100. At the same time, if it is the first scan line of the TFT array 100 be driven by the scan shift register 110, the first analog image signal will be stored into the cell E11 at the intersection of the first data line and the first scan line.

Subsequently, when the second digital image signal is inputted via the N data lines Din, the data switch C2 is switched on by the data shift register 105. The second digital image signal is then converted into a second analog image signal by means of the N-bit digital-to-analog converter D2, and the second analog image signal enters only the second data line of the TFT array 100. At the moment when the first scan line of the TFT array 100 is driven by the scan shift register 110, the second analog image signal is stored into the cell E12 at the intersection of the first scan line and the second data line.

The above-mentioned procedures are repeated for the same scan line by subsequently inputting digital image signals one by one, sequentially switching on data switches to allow one of the digital image signals to enter the TFT array 100 via a corresponding data line at one time, converting the digital image signals into analog image signals before they enter respective data lines of the TFT array 100, and successively storing the analog image signals to the cells electrically connected to the same scan line. Subsequently, the following scan lines of the TFT array 100 are driven by the scan shift register 110 row by row. The above-mentioned procedures are repeated for all the cells of the TFT array 100 sequentially and individually. In such way, a complete image frame will be displayed on the liquid crystal display.

It is known in the art that the image signals stored in the TFT array 100 need to be successively refreshed and store new image signals so as to display continuously refreshed image frames. Due to the persistence of vision of human eyes, the continuously refreshed image frames can be seen as a motion picture. However, undesirable twinkling image frames may still occur on the liquid crystal display if the refresh rate of the image frames is not high enough.

The manner for transferring image signals shown in FIG. 1(a) are so called series-input and series-output method. That is to say, image signals are inputted in series, and outputted in series to be stored into the TFT array 100. In other words, image signals are successively processed one by one. The capacitor of each cell in the TFT array 100 needs to be subjected to a charging/discharging cycle to store the corresponding analog image signal. Therefore, a certain period of time is required for successively charging/discharging all the capacitors.

With an increasing demand of high resolution of a liquid crystal display, the number of cells in the TFT array 100 are increased accordingly. Therefore, the overall period for charging/discharging the cells of each row and thus the open period of the data switches C1˜Cn increase. By the above-described frame-freshing method, the refresh rate of the image frames will be slowed down. Although the refresh rate of the image frames can be enhanced by shortening the period of the charging/discharging cycle for each cell, the analog image signal, in some cases, may not be completely transferred to the cell, so as to deteriorate the image quality.

For purpose of maintaining or even increasing the refresh rate of the image frames, another method was developed. According to such method, the thin film transistor array is divided into a plurality of bands. During operation of such liquid crystal display, image signals for several bands of cells are simultaneously processed, so as to improve the refresh rate. Since each band of cells has to be controlled by a driving circuit, a plurality of driving circuits are required to control the simultaneously operated bands. Therefore, the cost and complexity of overall driving circuitry are surely increased.

Furthermore, since the TFT array and the driving circuit of a liquid crystal display are separately fabricated conventionally, buses are required for connection. The additional cost associated with the buses is also undesirable.

### SUMMARY OF THE INVENTION

It is an object of the present invention to provide a device and a method for driving a liquid crystal display, in which the refresh rate of image frames are increased so as to enhance image quality of the liquid crystal display.

It is an object of the present invention to provide a device for driving a liquid crystal display having an integrated TFT array and driving circuit, so as to reduce cost.

In accordance with an aspect of the present invention, there is provided a device for driving a thin film transistor array of a liquid crystal display. The thin film transistor array comprises a plurality of data lines, a plurality of scan lines and a plurality of display cells. The device of the present invention comprises an input line, a plurality of latch units, and a plurality of digital-to-analog converters. The input line is used for receiving therefrom a plurality of digital image signals. The plurality of latch units are in communication with the input line for latching the digital image signals. The plurality of digital-to-analog converters are in communication with and disposed between the latch units and the data lines, for receiving more than one of the latched digital image signals, converting the latched digital image signals into analog image signals, and outputting the analog image signals to display cells in the same driven scan line via corresponding data lines synchronously.

In an embodiment, the plurality of latch units and the plurality of digital-to-analog converter are integrally formed on a display panel substrate.

In an embodiment, each of the latch units comprises a Static Random Access Memory (SRAM).

In an embodiment, the plurality of digital image signals are inputted via the input line and latched by the latched units successively. Furthermore, all of the latch units output the digital image signals successively latched therein synchronously.

In another embodiment, the device of the present invention further comprises a plurality of data switches and a data shift register. Each data switch is in communication with and disposed between the input line and one of the latch units. The data shift register is in communication with the plurality of data switches, and switching on the plurality of data switches one by one.

In another embodiment, the device of the present invention further comprises a plurality of enabling switches in communication with and disposed between the latch units and the digital-to-analog converters, and allowing the more than one latched digital image signals to be transmitted to corresponding ones of the digital-to-analog converters synchronously in response to an enabling signal. In another embodiment, the device of the present invention further comprises a scan shift register electrically connected to the plurality of scan lines, and driving one of the scan lines to have the analog image signals outputted to display cells in the driven scan line in response the enabling signal.

In an embodiment, the input line is an N-bit input bus comprising of N input data lines, and each of the digital-to-analog converters is of N bits.

In accordance with another aspect of the present invention, there is provided a device for driving a thin film transistor array of a liquid crystal display. The device comprises an N-bit input line, a plurality of data switches, a data shift register, a plurality of latch units, and a plurality of N-bit digital-to-analog converters. The N-bit input line is employed for successively receiving therefrom a plurality of digital image signals. The plurality of data switches are electrically connected to the N-bit input line, and successively switched on to allow the digital image signals to pass therethrough in sequence. The data shift register is electrically connected to the plurality of data switches, and successively switching on the data switches one by one. The plurality of latch units are electrically connected to the data switches, latching the digital image signals passing through the data switches being switched on, and outputting the latched digital image signals synchrounously in response to an enabling signal. The plurality of N-bit digital-to-analog converters are electrically connected to the latch units for receiving and converting the latched digital image signals into analog image signals to be provided for the thin film transistor array.

In an embodiment, the device of the present invention further comprises a plurality of enabling switches electrically connected between the latch units and the N-bit digital-to-analog converters, and the plurality of enabling switches are simultaneously switched on in response to the enabling signal to allow the latched digital image signals to be outputted from the latch units to the N-bit digital-to-analog converters synchronously.

In an embodiment, the thin film transistor array, the plurality of data switches, the plurality of latch units, the plurality of enabling switches and the plurality of N-bit digital-to-analog converters are integrally formed on a display panel substrate.

In an embodiment, the analog image signals are transferred to the thin film transistor array synchronously via a plurality of data lines of the thin film transistor array electrically connected to the plurality of N-bit digital-to-analog converters, respectively.

In an embodiment, the device of the present invention further comprises a scan shift register electrically connected to a plurality of scan lines of the thin film transistor array, and successively driving the scan lines to have the analog image signals outputted to display cells of the thin film transistor array in the scan line being driven via the plurality of data lines.

In accordance with another aspect of the present invention, there is provided a method for driving a thin film transistor array of a liquid crystal display. The thin film transistor array comprising a plurality of data lines, a plurality of scan lines and a plurality of display cells. The method of the present invention comprises the following steps. Firstly, a series of digital image signals is received. Then, the series of digital image signals are successively latched. The latched digital image signals are converted into analog image signals. Then, the analog image signals are synchronously outputted via respective data lines to display cells associated with a driven scan line in response to an enabling signal. Afterwards, the above steps are repeated to provide further analog image signals for display cells associated with next driven scan line.

In an embodiment, the latched digital signals are synchronously converted into the analog image signals in response to the enabling signal.

In an embodiment, the method of the present invention further comprises a step of sequentially driving the scan lines of the thin film transistor array at a time interval no less than a time period required for synchronously storing the analog image signals into the display cells associated with the driven scan line.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic circuit block diagram illustrating the configuration of the driving circuit and active matrix of a conventional liquid crystal display;

FIG. 1(b) is a view illustrating a cell of the thin film transistor array for a typical liquid crystal display; and

FIG. 2 is a schematic circuit block diagram illustrating the configuration of the driving circuit and active matrix of a liquid crystal display according to a preferred embodiment of the present invention.

### DETAILED DESCRIPTION OF THE PREFERRED EMBODIMENT

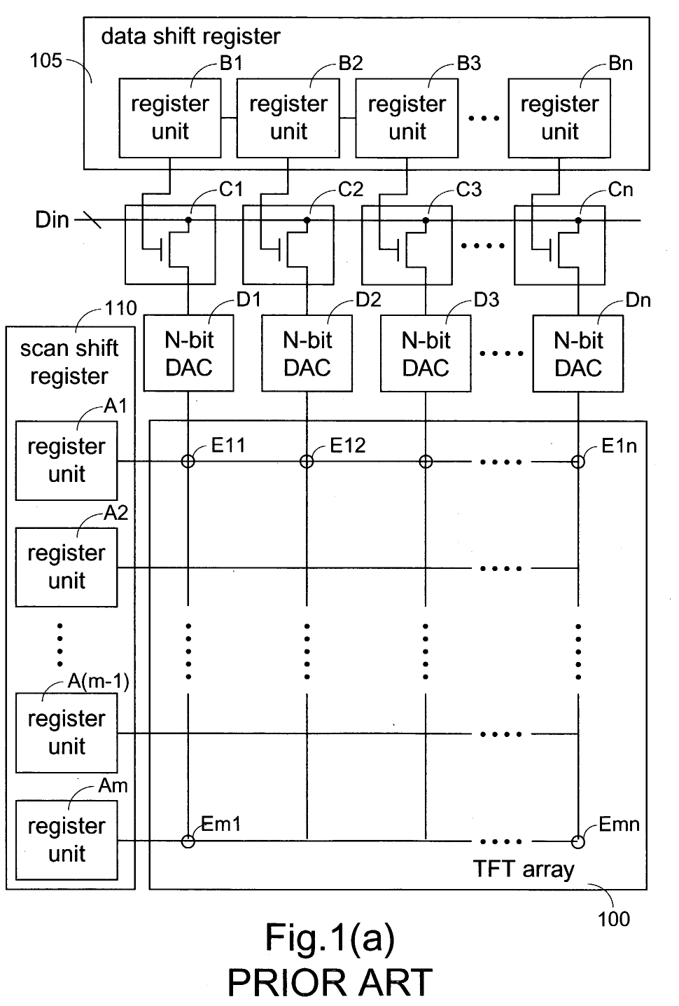

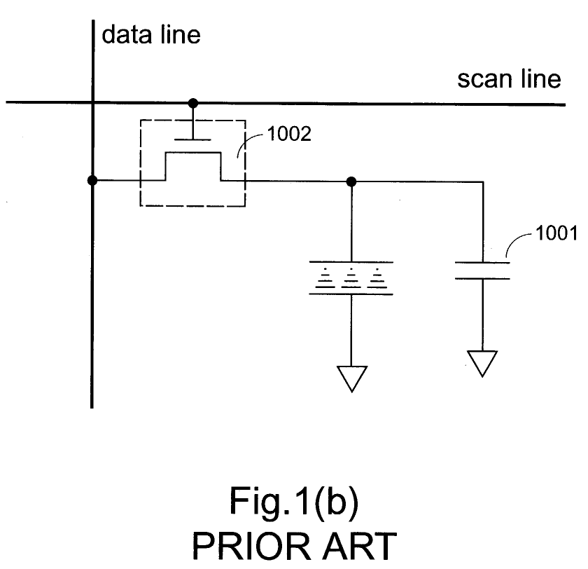

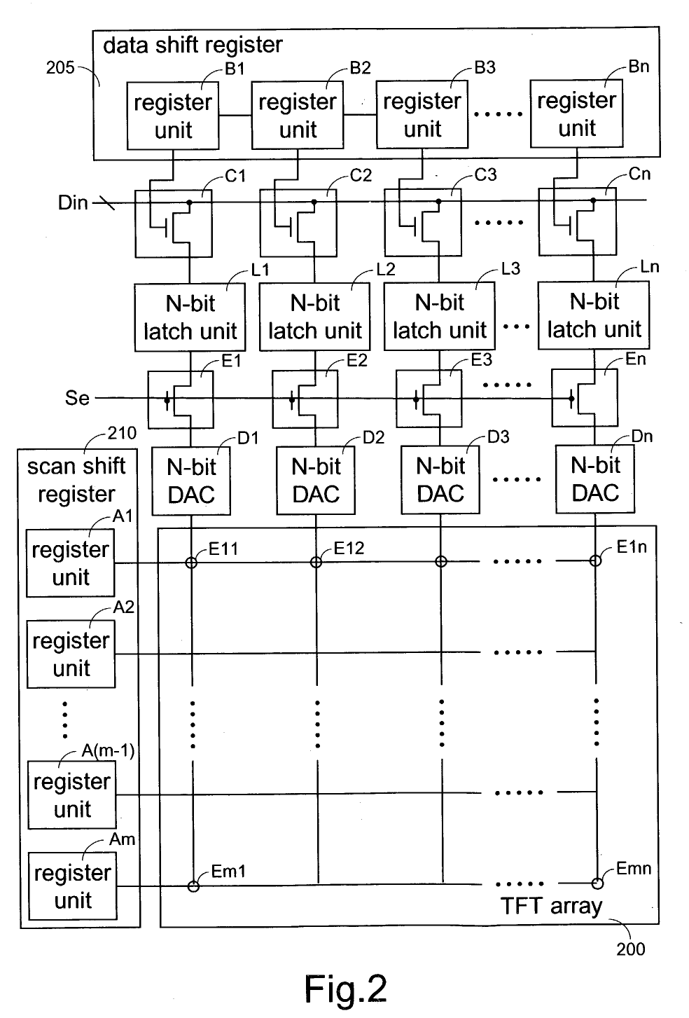

FIG. 2 is a schematic circuit block diagram illustrating the configuration of the driving circuit and active matrix of a liquid crystal display according to a preferred embodiment of the present invention. The elements corresponding to those in FIG. 1(a) will be designated by identical numeral references.

The active matrix is implemented by a thin film transistor array (TFT array) 100. The TFT array 100 further comprises a plurality of scan lines and data lines. Via each scan line, all the thin film transistors of the same row are controlled in either a switching-on or switching-off state. By the driving circuit, the data lines transmit analog image signals to the switched-on cells electrically connected thereto.

The driving circuit comprises a data shift register 105, a scan shift-register 110, a plurality of data switches C1˜Cn, a plurality of N-bit latch units L1˜Ln, a plurality of enabling switches E1˜En and a plurality of N-bit digital-to-analog converters (DACs) D1˜Dn.

The scan shift register 110 comprises a plurality of scan register units A1˜Am, which are electrically connected in series with each other. Each of the scan register units A1˜Am is electrically connected to a corresponding scan line. The scan lines are successively driven by the scan shift register 110 so as to sequentially turn on the thin film transistors row by row. The data shift register 105 comprises a plurality of data register units B1˜Bm. The data register units B1˜Bm successively switch on the data switches C1˜Cn. Each of the data switches C1˜Cn comprises N transistors. For neat drawings, however, only one transistor is shown in the drawing. When a data switch is turned on, the digital image signals inputted from N data lines Din simultaneously pass through the N transistors.

The N-bit latch units L1˜Ln are electrically connected to the data switches C1˜Cn. The digital image signals passing through the data switches in switched-on states will be latched by theses N-bit latch units L1˜Ln. Each of the N-bit latch units can be an embedded SRAM of N bits or other suitable latching circuit. Since the access speed of an SRAM is much higher than that of the storage capacitor of the display cell in the TFT array 100, all the digital image signals to be provided for the display cells of the same row can be successively latched by the latch units L1˜Ln at a considerably fast speed.

The enabling switches E1˜En are electrically connected between the latch units L1˜Ln and the N-bit digital-to-analog converters D1˜Dn. The enabling switches E1˜En are simultaneously switched on in response to an enabling signal Se to allow the latched digital image signals to be outputted from the latch units L1˜Ln to the N-bit digital-to-analog converters D1˜Dn synchronously. Similarly, each of the enabling switches E1˜En comprises N transistors. For neat drawings, however, only one transistor is shown in the drawing. When the enabling switches are turned on, the latched digital image signals simultaneously pass through the (N×n) transistors.

The latched digital image signals are then transmitted to the N-bit digital-to-analog converters D1˜Dn and then converted into corresponding analog image signals. These analog image signals are then synchronously outputted via respective data lines of the TFT array 100 to display cells associated with a driven scan line.

The operation of the above circuit will be further illustrated as follows.

When the first digital image signal is inputted via the N data lines Din, the data switch C1 is switched on by the register unit B1, and meanwhile the other data switches are kept off. Then, the first digital image signal passing through the data switch C1 is latched by the N-bit latch unit L1. Subsequently, the second digital image signal is inputted via the N data lines Din, and the data switch C2 is switched on by the register unit B2 with the other data switches being kept off. Similarly, the second digital image signal passing through the data switch C2 is latched by the N-bit latch unit L2. The above-mentioned procedures are repeated for processing the third to the nth digital image signals so as to successively latch the series of digital image signals received from the N data lines Din and passing through the data switches C1˜Cn by the N-bit latch units L1˜Ln, respectively.

In response to the enabling signal Se, the enabling switches E1˜En are synchronously switched on, and the latched digital signals are synchronously converted into corresponding analog image signals by means of the N-bit digital-to-analog converters D1˜Dn. In such way, the analog image signals are synchronously outputted via respective data lines to display cells E11˜E1n associated with a scan line of the TFT array 100 driven by the register unit A1. At the moment when the display cells E1˜E1n are charged by these parallel outputs, next series of digital image signals are successively latched by the latch units L1˜Ln, and to be synchronously converted into analog image signals and provided for the display cells E21˜E2n associated with a scan line of the TFT array 100 driven by the register unit A2.

For the display cells E21˜E2n of the second row driven by the same scan line, input digital image signals one by one sequentially pass through the correspondingly switched-on data switches C1˜Cn to allow the digital image signals to be latched by the N-bit latch units, synchronously pass through the enabling switches simultaneously switched on in response the enabling signal to be converted into analog image signals by the DACs D1˜Dn, and synchronously transmitted to the display cells E21˜E2n via respective data lines. Subsequently, the following scan lines of the TFT array 100 are driven by the scan shift register 110 row by row. In such way, a complete image frame will be displayed on the liquid crystal display.

The manner for transferring image signals shown in FIG. 2 can be referred as a series-input and parallel-output method. That is to say, the digital image signals are inputted in series into the latch units, and the analog image signals converted from the latched digital image signals are outputted in parallel to the TFT array 100. Since all the digital image signals to be provided for the display cells of the same row are completely latched by the latch units L1˜Ln within a very short period, enough time is reserved for the operation of the storage capacitors of the display units, thereby assuring of good image quality. Alternatively, a relatively short period is required for the synchronous charging/discharging operation of the storage capacitors, thereby enhancing the refresh rate. In addition, the TFT array according to the present invention is suitable to be operated by a single driving circuit, so as to be cost-effective.

It is known in the art that a TFT having a polysilicon layer is produced by a laser annealing procedure at a relatively low temperature. Such low-temperature polysilicon thin film transistor (LTPS-TFT) has improved electrical properties of TFT transistors and the TFT transistors can be directly formed on a glass substrate. The electron mobility for such LTPS-TFTLCD is considerably larger than the conventional TFTLCD. The present invention is adapted to be used for LTPS-TFTLCD. Further, the driving circuit and active matrix of the present invention can be integrated or embedded into a display panel substrate so as to reduce the fabricating cost.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A device for driving a thin film transistor array of a liquid crystal display, said thin film transistor array comprising a plurality of data lines, a plurality of scan lines and a plurality of display cells, said device comprising:
an input line for receiving therefrom a plurality of digital image signals;
a plurality of latch units in communication with said input line for latching said digital image signals; and
a plurality of digital-to-analog converters in communication with and disposed between said latch units and said data lines, for receiving more than one of said latched digital image signals, converting said latched digital image signals into analog image signals, and outputting said analog image signals to display cells in the same driven scan line via corresponding data lines synchronously.

2. The device according to claim 1 wherein said thin film transistor array, said plurality of latch units and said plurality of digital-to-analog converter are integrally formed on a display panel substrate.

3. The device according to claim 1 wherein each of said latch units comprises a Static Random Access Memory (SRAM).

4. The device according to claim 1 wherein said plurality of digital image signals are inputted via said input line and latched by said latched units successively.

5. The device according to claim 4 wherein all of said latch units output said digital image signals successively latched therein synchronously.

6. The device according to claim 4 further comprising:
a plurality of data switches each in communication with and disposed between said input line and one of said latch units; and
a data shift register in communication with said plurality of data switches, and switching on said plurality of data switches one by one.

7. The device according to claim 1 further comprising a plurality of enabling switches in communication with and disposed between said latch units and said digital-to-analog converters, and allowing said more than one latched digital image signals to be transmitted to corresponding ones of said digital-to-analog converters synchronously in response to an enabling signal.

8. The device according to claim 7 further comprising a scan shift register electrically connected to said plurality of scan lines, and driving one of said scan lines to have said analog image signals outputted to display cells in said driven scan line in response said enabling signal.

9. The device according to claim 1 wherein said input line is an N-bit input bus comprising of N input data lines, and each of said digital-to-analog converters is of N bits.

10. A device for driving a thin film transistor array of a liquid crystal display, comprising:
an N-bit input line for successively receiving therefrom a plurality of digital image signals;
a plurality of data switches electrically connected to said N-bit input line, and successively switched on to allow said digital image signals to pass therethrough in sequence;
a data shift register electrically connected to said plurality of data switches, and successively switching on said data switches one by one;
a plurality of latch units electrically connected to said data switches, latching said digital image signals passing through said data switches being switched on, and outputting said latched digital image signals synchronously in response to an enabling signal; and
a plurality of N-bit digital-to-analog converters electrically connected to said latch units for receiving and converting said latched digital image signals into analog image signals to be provided for the thin film transistor array.

11. The device according to claim 10 further comprising a plurality of enabling switches electrically connected between said latch units and said N-bit digital-to-analog converters, and said plurality of enabling switches are simultaneously switched on in response to said enabling signal to allow said latched digital image signals to be outputted from said latch units to said N-bit digital-to-analog converters synchronously.

12. The device according to claim 11 wherein said thin film transistor array, said plurality of data switches, said plurality of latch units, said plurality of enabling switches and said plurality of N-bit digital-to-analog converters are integrally formed on a display panel substrate.

13. The device according to claim 10 wherein each of said latch units comprises a Static Random Access Memory (SRAM).

14. The device according to claim 10 wherein said analog image signals are transferred to said thin film transistor array synchronously via a plurality of data lines of said thin film transistor array electrically connected to said plurality of N-bit digital-to-analog converters, respectively.

15. The device according to claim 14 further comprising a scan shift register electrically connected to a plurality of scan lines of said thin film transistor array, and successively driving said scan lines to have said analog image signals outputted to display cells of said thin film transistor array in said scan line being driven via said plurality of data lines.

16. A method for driving a thin film transistor array of a liquid crystal display, said thin film transistor array comprising a plurality of data lines, a plurality of scan lines and a plurality of display cells, said method comprising steps of:
receiving a series of digital image signals;
successively latching said series of digital image signals; and
converting said latched digital image signals into analog image signals;
synchronously outputting said analog image signals via respective data lines to display cells associated with a driven scan line in response to an enabling signal; and
repeating said above steps to provide further analog image signals for display cells associated with next driven scan line.

17. The method according to claim 16 wherein said latched digital signals are synchronously converted into said analog image signals in response to said enabling signal.

18. The method according to claim 16 further comprising a step of sequentially driving said scan lines of said thin film transistor array at a time interval no less than a time period required for synchronously storing said analog image signals into said display cells associated with said driven scan line.

19. The method according to claim 16 wherein said digital image signals are latched by a Static Random Access Memory (SRAM).
